(19) United States
(12) Patent Application Publication
(10) Pub. No.: US 2014/0054339 A1
(43) Pub. Date: Feb. 27, 2014

(54) Articulating Containment Space for a Motor Vehicle

(71) Applicant: David Randolph Smith, Midland, TX (US)

(72) Inventor: David Randolph Smith, Midland, TX (US)

(21) Appl. No.: 13/973,701

(22) Filed: Aug. 22, 2013

Related U.S. Application Data
(60) Provisional application No. 61/692,130, filed on Aug. 22, 2012.

(51) Int. Cl. B60R 9/06

(52) U.S. Cl. CPC B60R 9/06
USPC 224/404; 29/428

(57) ABSTRACT

A containment space body may form an enclosurement space of a motor vehicle and be articulated relative to the motor vehicle. The containment space may be used to store, isolate, and/or protect tools, batteries, food stuffs, pets, fuels, water, gases, welding machines, and many other useful devices or items from the ambient environment outside the containment space. An articulating containment space body for a motor vehicle may form an enclosurement space with a space on board a motor vehicle. The articulating containment space body may articulate such that it maintains a plane parallel to the earth's horizon throughout the articulation path. The articulation mechanism assembly and attachment means to the articulation mechanism assembly of the containment space bodies may allow for rapid and easy exchange of different containment space bodies.

### CROSS-REFERENCE TO RELATED APPLICATIONS

This application claims benefit of priority of U.S. Provisional Patent Application No. 61/692,130 filed on Aug. 22, 2012, and entitled “METHOD AND APPARATUS TO FORM AN ARTICULATING CONTAINMENT SPACE FOR A MOTOR VEHICLE,” which is hereby incorporated by reference.

### TECHNICAL FIELD

This application is related to motor vehicles. More specifically, this application is related to containment space for motor vehicles.

### BACKGROUND

Tool boxes for work trucks, such as pick-up trucks, are a useful device to protect and organize tools, parts, and other goods in the bed of a truck. There are many designs, locations, and configurations of such tool boxes, but conventional tool boxes consume a significant portion of the pick-up bed space rendering the space in the pick-up bed occupied by the tool box space unusable for loading other items. A typical pick-up bed is typically approximately 8 feet long. The addition of a 2 foot wide tool box to the pick-up bed reduces the available space in the bed by 25% or more. One conventional toolbox allows sliding of tool box relative to the pick-up truck, but does not move the tool box below the plane of the pick-up bed floor, thereby obstructing the placement of items in the pick-up bed floor. Other conventional toolboxes are rigidly fixed into a position in the pick-up bed or slide along the plane of the pick-up bed floor.

Furthermore, the advent of pick-up trucks using large tires or extended suspension systems, known as monster trucks, render the height of a tool box located in the such pick-up beds to be too high above ground for an average person to reach from the ground. This then makes the contents of the tool box difficult to access from the ground.

### BRIEF SUMMARY

Embodiments presented below are directed to methods and apparatuses to form an articulating containment structure, having a containment space body, for a motor vehicle that may also enclose a space in the motor vehicle. In certain embodiments, the use of an articulating containment space body for a motor vehicle may also function as an enclosurement of a space on board a motor vehicle, similar to a tailgate on a pick-up truck, sport utility vehicle (SUV), or mini-vans. Certain embodiments of this disclosure may provide an articulating containment space having the functionality of closure of a motor vehicle space similar to a tail gate as well as the added functionality of storing items in the articulating containment space. In one embodiment, the articulation of the containment space body allows the contents of the containment space to remain on the same plane relative to the earth throughout the articulation path. That is, the contents are not rotated and remain parallel to the ground while the containment space is articulated through the path. In one embodiment, the containment space may be a tool box located on a distal end of the bed of a pick-up truck or other vehicle, in which the tool box also functions as the tailgate of the pick-up bed when the tool box is articulated from a lower, or displaced, position to an upper position in the pick-up bed. In certain embodiments, the containment space may contain a variety of items, including but not limited to tailgate party devices and food and drinking items, and/or animal transport spaces. In one embodiment, the articulating containment space may be traded out from a motor vehicle to accommodate many situations, from work to party to hunting. For example, the containment space may include components for operation of the car or other devices, such as battery cells and fuel cells, that may be traded for charged battery cells or fuel cells.

In certain embodiments, a containment space may articulate up and down from the distal end of a motor vehicle giving access to vehicle while retaining the same plane of orientation for items located in the containment space from the vertical position to the horizontal position.

In certain embodiments, the end location of a motor vehicle where the closure gate is normally located is provided with a containment space body configured to form an enclosure for the vehicle and a convenient storage space for various items such as tools, beverages, foods, drinks, fuels, batteries, and/or refrigeration devices. This containment space body is not limited to containing tools, but may be used to contain food, drinks, cooking utensils, refrigerators, stoves, ovens, stereo equipment, animals, etc. It is well known to those familiar with the art of “tail gating” that pick-up tail gates are designed from the factory to be easily removable. Many vehicles have conveniently located near the tail gate electrical outlets from the pick-up trucks electrical system that can be connected to the containment space body and articulation device apparatus disclosed herein for operation of articulation methods and other electrical uses of devices incorporated into the containment space body.

In one embodiment, the containment space may articulate to a position below or above the vehicle's interior space to allow access to the vehicle's interior space, such as a pick-up bed or a mini-van trunk. Furthermore, the containment space may articulate in such a manner as to not disrupt the position of items stored inside it. In one embodiment the containment space body articulates through a path such that the containment space body is always level with the earth. In this embodiment during the articulation of the containment space, the storage box may maintain the same plane throughout the articulation, such that materials inside the containment space remain in the same relative position inside the containment space at all points along during the articulation process.

In certain embodiments, the containment space may be located on the distal end of the motor vehicle and allow access to the containment space body in both the vertical inclination as well as the horizontal inclination through various features of the containment space. For example, a tool box containment space may have a door or hatch on the back face of the distal end allowing for access to the containment space body from standing on the ground. In some embodiments where the motor vehicle is high off the ground the articulation makes this back face hatch accessible once the tool box is lowered on monster type trucks where the bed of the pick-up and tailgate a significantly high off the ground. In other embodiments the contents and items contained by the containment space can be accessed through the top through various features.

According to one embodiment, a method to form an enclosurement space with a motor vehicle storage space using an articulating containment space body is disclosed. The method may include connecting at least one articulating device assembly to a the motor vehicle; attaching the at least one articulating device assembly to the containment space body; supplying power from at least one power source to the at least one articulating device assembly; articulating a displacement motion of the containment space body relative to the motor vehicle from an enclosurement position in the motor vehicle; and/or articulating a restoration motion of the containment space to the enclosurement position in the motor vehicle.

In certain embodiments, the displacement or restoration articulation does not substantially change an orientation of material stored inside the containment space body as the containment space is articulated; articulating a restoration motion of the containment space to the enclosurement position in the motor vehicle encloses a portion of the motor vehicle storage space; the power source comprises at least electrical power; the power source comprises at least hydraulic power; the power source comprises human power; the power source comprises at least power from a mechanical device, including at least one of a pulley, a lever, a gear, a spring, and a wheel.

In certain embodiments, the method may also include articulating the containment space along a path such that the containment space horizontal plane remains parallel relative to the earth's ground throughout the articulation; articulating the containment space body to a position below a bottom of the motor vehicle storage space; powering the motor vehicle from a power source stored within the containment space body; supplying power to the at least one articulating device assembly from a power source from the motor vehicle; refrigerating the containment space; lowering the containment space from the enclosure position and removing the containment space from the motor vehicle; interchanging containment space bodies; and/or moving a surface of at least a portion of the containment space body.

According to another embodiment, an apparatus may include a storage unit configured to be docked to a space on board a motor vehicle and an articulating assembly connected to the motor vehicle and configured to articulate the storage unit relative to the motor vehicle.

In certain embodiments, the storage unit may include an energy source configured to provide energy to actuate the articulating assembly and move the storage unit relative to the motor vehicle; the storage unit may include electrical connections configured to be connected to an electrical power system of the motor vehicle; the storage unit may include hydraulic connections configured to be connected to a hydraulic power system of the motor vehicle; the storage unit may include at least one mechanism that allows the passage of materials at least from inside the storage unit to the outside of storage unit; the storage unit may include at least one of an access door, a hatch, and a window to the interior of the storage unit; the storage unit may be configured to extend out of the a containment space body surrounding the storage unit upon pulling the storage unit; the storage unit may include an electrical battery; the storage unit may include a fuel cell; the storage unit may include a sealed vessel; the storage unit may include electrical outlets and the electrical outlets are connected electrically to an electrical power supply; the storage unit may include electrical devices connected to an electrical system of the motor vehicle; and/or the storage unit may include insulation.

In certain embodiments, the apparatus may also include at least one of a caster and a wheel on a bottom face of the storage unit.

According to yet another embodiment, a method to articulate containment space bodies for motor vehicles is disclosed. The method may include connecting at least one powered articulating assembly to the motor vehicle; connecting the at least one powered articulating assembly to at least one power source; supplying power from the at least one power source to the articulating assembly; engaging the containment space body with the articulating assembly; and/or articulating the containment space body relative to the motor vehicle.

In certain embodiments, the containment space body is articulated on a path such that the horizontal axis of the containment space largely may remain parallel to the earth's horizon; the containment space body forming an enclosurement space aboard the motor vehicle; and/or the motor vehicle storage space enclosurement device may include an articulating containment space body.

In certain embodiments, the method may also include changing a plurality of interchangeable containment space bodies configured to engage, connect, and/or operate with the articulating assembly attached to the motor vehicle.

In certain embodiments, a cover enclosurement device is connected to the motor vehicle storage space and an articulating containment space body may form a further enclosurement with motor vehicles cover enclosurement device.

In certain embodiments, the method of connecting devices such as video screen devices to an outward face of the containment space body; connecting aerodynamic surface members to the containment space body; connecting video cameras to the containment space body; connecting proximity sensors to the containment space body; and/or connecting lights to the containment space body, and incorporating the transmission of input and output information and data between the motor vehicle, the internet and these connected devices.

In certain embodiments, the method may include attaching to the containment space body's outer surface removable structural images, in which the structural image includes a functional securing member and the securing mechanism is located on an inner surface of containment surface. The structural images may comprise trademarks, advertisements, signatures, icons, words, emblems, insignia, or ornaments to the articulating containment space. In some embodiments, these attached images are removable and different structural images maybe interchanged, attached, and secured to the containment space. One illustrative example of a structural image attachment means comprises a plate containing the image of an animal on the outward face of the image plate attached to the outward face of a containment space body, in which the plate has on its inner-facing face connected to a bolt that penetrates the containment space body. The bolt attached to the image plate is secured with an attachment means on the inside of the containment space body to functionally connect and maintain the structural images position to the containment space body.

According to a further embodiment, an articulation apparatus a containment space body of a motor vehicle in a plane level to the Earth's horizontal plane is disclosed. The apparatus may include a gear mechanism connected to a shaft, wherein the shaft is connected to at least two lifting arm members, wherein the at least two lifting arm members are configured to allow rotation relative to a pivot mechanism and the at least two lifting arm members, wherein the pivot mechanisms are connected to two sides of the containment space body above a center of gravity of the containment space; and/or an electrical motor connected to an electrical power source and the articulation apparatus.

In certain embodiments, the articulation apparatus may be configured to move the containment space body between an enclosurement position and an extended position; and/or the gear mechanism may be configured to move the containment space body below a bottom of the motor vehicle in the extended position.

Items as defined herein are any states and combinations of states of matter that can be confined within a space. States of matter include liquids, gases, solids, and plasmas.

Docking station herein is defined to be a position wherein the containment space body is normally located when the motor vehicle is moving.

A containment space body as defined herein is any assembly that forms a space where items, like liquids, gases, or solids may be held within the assembly's containment space.

Articulation as defined herein as any movement in any direction of the motor vehicle.

“Forming an Enclosurement” as defined herein is the method of forming at least a partially closed space that may contain items. A formed enclosurement herein does not necessarily have to be air tight. For example, a tail gate on a pick-up truck may form an enclosurement, but the top of the pick-up bed is open and still the enclosurement formed by closing a tail gate on the back of the pick-up at least contains some items within the pick-up bed.

A motor vehicle storage space is defined herein as any cavity on board a motor vehicle that constitutes a free space aboard the motor vehicle. This includes but is not limited to, trunks, frunk, pick-up beds, passenger spaces, and other storage and cargo spaces on board motor vehicles.

Proximity sensors as defined herein are sensors that alert or inform a motor vehicle operator, computer, or internet connected device that the motor vehicle is nearing an object.

A visual image as defined herein is any work of art, trademark, advertisement, signature, icon, words, emblem, insignia, or ornament.

A frunk is defined herein as storage space located on the front of a motor vehicle.

A trunk is defined herein as a storage space located at the rear of a motor vehicle.

An aerodynamic surface is herein defined as any surface that affects the coefficient of drag of air.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 illustrates a perspective view of a motor vehicle connected to a containment space body herein represented as a toolbox displaced from its docking station in the pick-up bed to a lowered position below the floor of the pick-up bed according to one embodiment.

FIGS. 2 and 3 illustrate perspective views of subsequent positions of the containment space body herein represented as a toolbox in FIG. 1 during articulation in a generally upward direction of containment space body or toolbox.

FIG. 4 illustrates a perspective view of the containment space or toolbox of FIG. 1 in a final enclosurement docked position wherein the containment space body, tool box, forms an enclosurement of the pick-up bed according to one embodiment.

FIG. 5 illustrates another perspective view of a containment space body or toolbox of the pick-up truck motor vehicle where the containment space tool box is disconnected from the pick-up according to one embodiment. FIG. 5 further exemplifies the articulation of the containment space box wherein the containment space remains largely parallel to the horizontal plane of the earth.

FIG. 6 illustrates a perspective view of a motor vehicle with one embodiment of this articulation assembly located on the distal end of a pick-up truck bed connected to a containment space body, such as a tool box, in the docked upper position inside the motor vehicle bed forming an enclosurement with the motor vehicle bed.

FIG. 7 illustrates a view from the distal end of a pick-up truck looking forward of one embodiment of this articulation assembly wherein a tool box is in the docked upper position.

FIG. 8 illustrates a perspective view of a motor vehicle, in this case a pick-up truck, with one embodiment of an articulation assembly located on the distal end of a pick-up truck bed connected to a containment space body, such as a tool box, articulated out from the docked position to a position below the bed of the pick-up truck.

FIG. 9 illustrates a view from the distal end of a pick-up truck looking forward of one embodiment of an articulation assembly wherein a tool box is in a displaced lower position, such that the lowered position of the containment space allows full access to the bed of the pick-up truck.

### DETAILED DESCRIPTION

As used herein, “a” or “an” means one or more. Unless otherwise indicated, the singular contains the plural and the plural contains the singular. Where the disclosure refers to “perforations” it should be understood to mean “one or more perforations.”

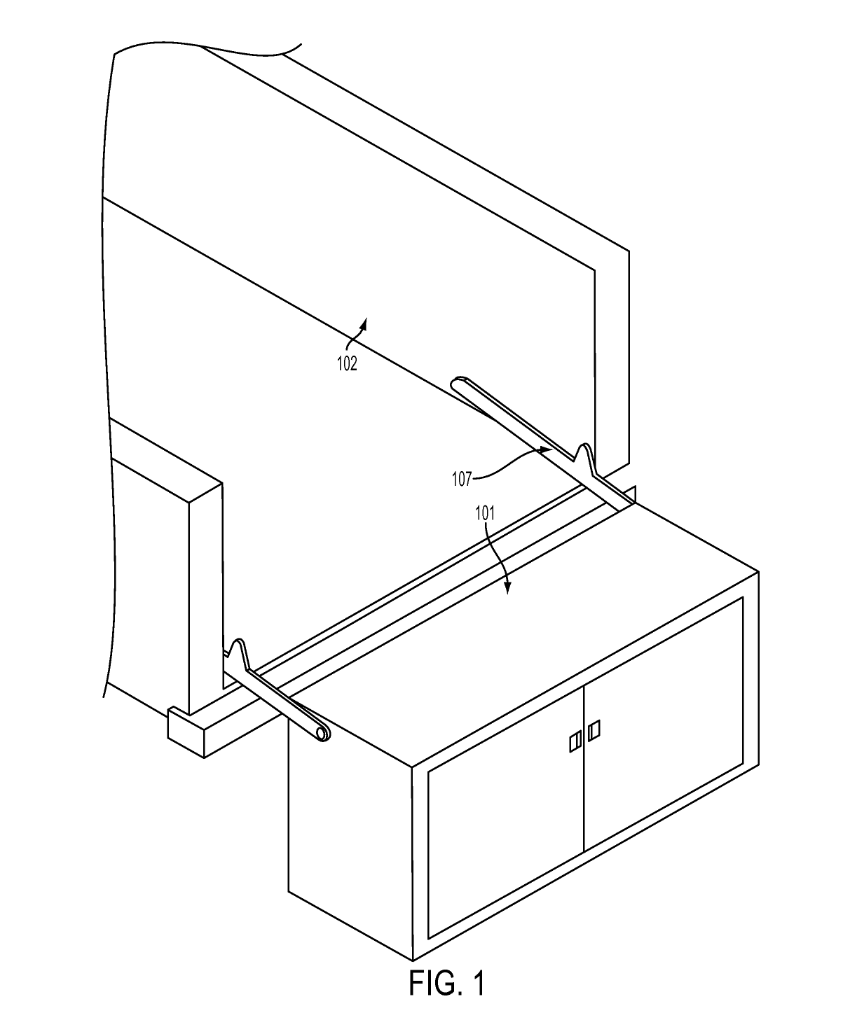

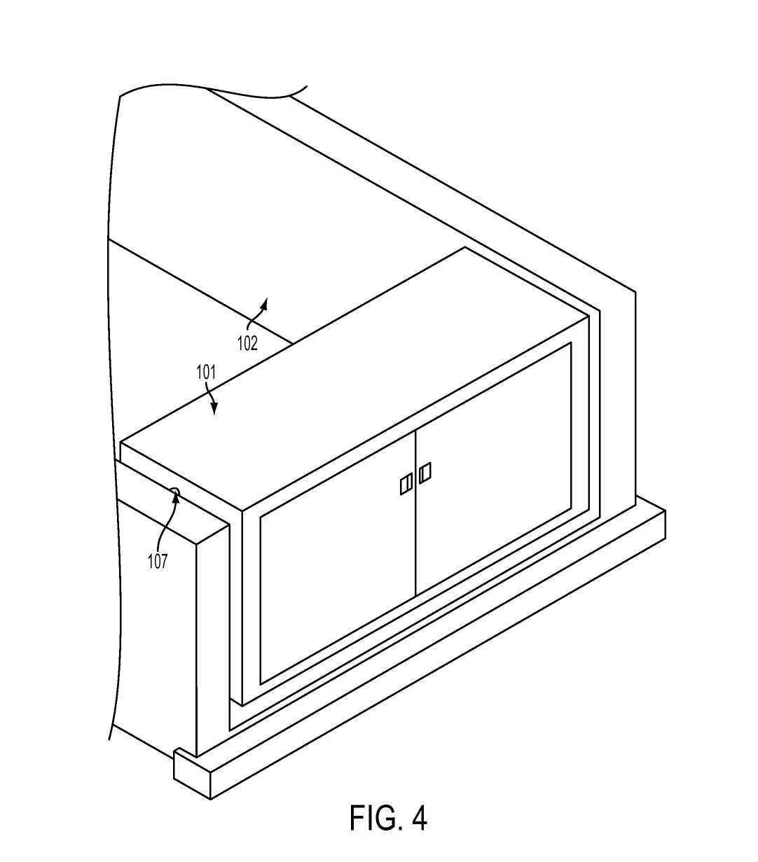

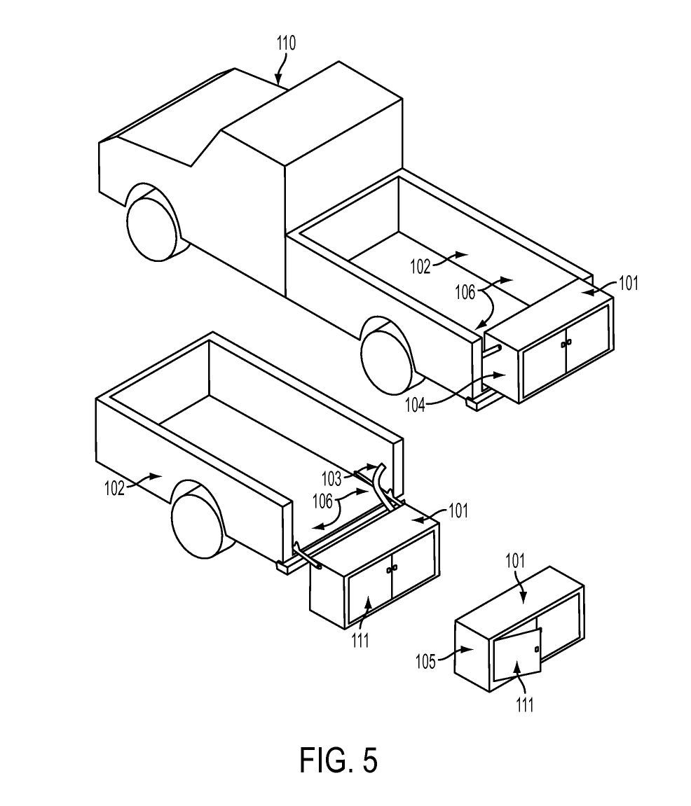

Referring to FIGS. 1-4, there is provided containment space body or storage unit 101 coupled to cargo carrying area (or bed) 102 of a motor vehicle 110 of FIG. 5 (wherein FIGS. 1-4 are partial view of the back of the motor vehicle 110), such as a pick-up truck. Storage unit 101 may be configured to articulate along an arc path to a generally upper docking position shown in FIG. 4, in which the containment space body's bottom aligns generally with the floor of the motor vehicle 110 of FIG. 5 to enclose cargo carrying area 102. Access doors may be located on the containment space body 101 to allow access to it from the ground. In one embodiment, storage unit or containment space 101 is a steel tool box configured to contain a variety of tools, parts, electrical devices, as well as other items.

The dimensions of storage unit 101 can vary as applicable. One factor that can affect the dimensions of storage unit 101 is the dimensions of the particular cargo carrying area to be enclosed and equipped with a storage unit 101 as described herein. In one embodiment, the dimensions of storage unit 101 should generally correspond so its width and height and extend sufficiently to enclose the space of the particular cargo carrying area to adequately provide an enclosed area. The depth of the storage unit 101 can vary depending on the particular containment space required for a variety of purposes.

Moreover, the storage unit 101 can have a variety of docking positions. For example, a docking station does not necessarily have to configure the outward facing portion of storage unit 101 even with the body of the motor vehicle, thereby reducing the space occupied by the storage unit inside the motor vehicle storage space. Storage unit 101 can be made of any of a variety of durable materials, including plastics, metals, and/or a combination thereof. Furthermore, storage unit 101 can be of any design, such as one or more storage areas, doors, shape, color, etc. Moreover, the containment space body can be of any general geometrical shape, including but not limited to a rectangles, cylinders, attached aerodynamic surfaces, curves, and any combination of shapes and surfaces.

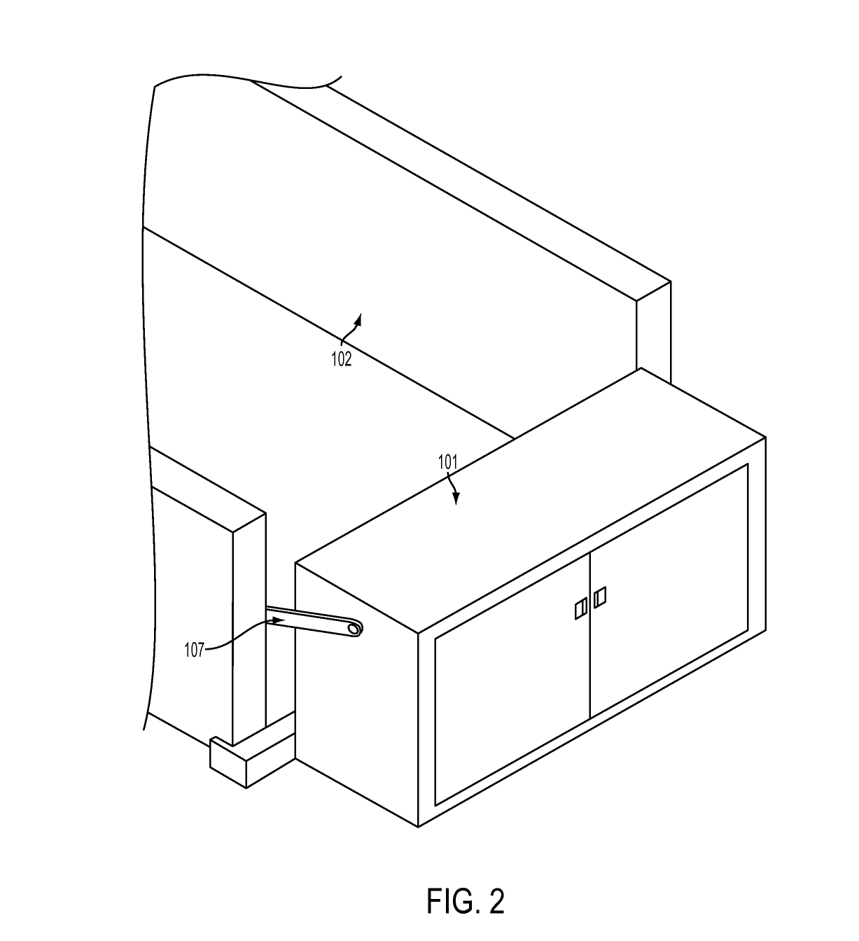

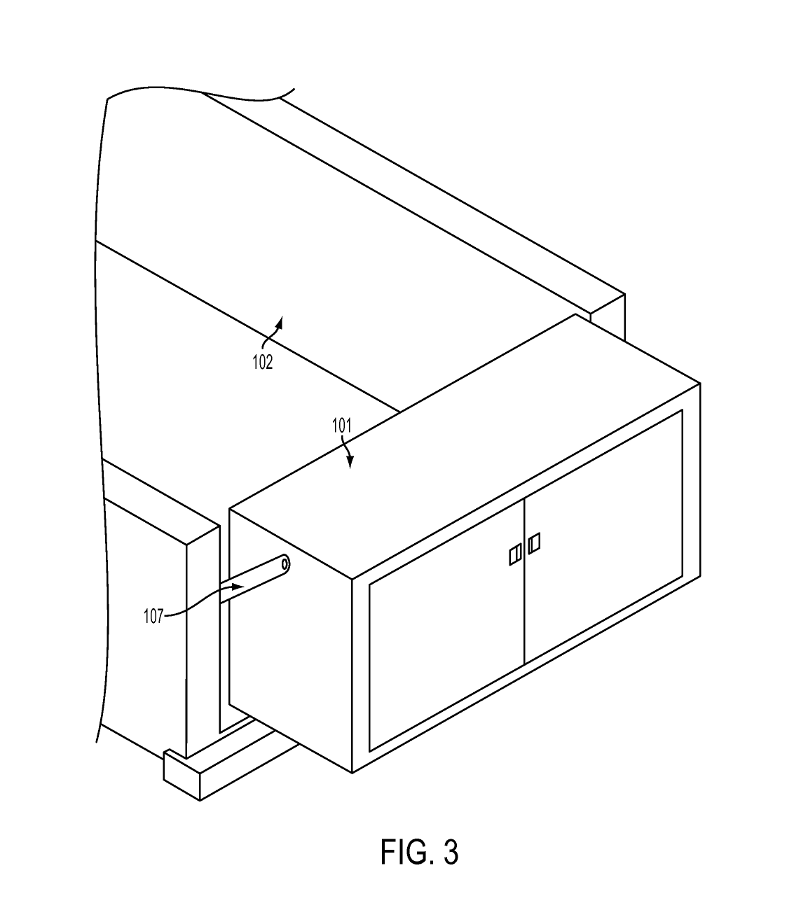

In FIG. 1, storage unit 101 is in a displaced position, where storage unit 101 is at least partially below the plane of the floor of the motor vehicle cargo carrying area 102. In one embodiment, the use of the storage unit 101 does not inhibit access to the cargo carrying area 102. Storage unit 101 may further comprise two arms 107 attaching storage unit 101 to cargo carrying area 102. Arms 107 may be connected to motors, displacement cylinders as well as the storage unit 101 to articulate, preferably electrically, the storage unit 101 from the displaced position in FIG. 1 into a docking position as shown in FIG. 4 to enclose cargo carrying area 102. FIGS. 2 and 3 show the positions of storage unit 101 and arms 107 during this upward movement. The movement may be viewed sequentially through FIGS. 1, 2, 3 and 4 such that the storage unit 101 maintains a horizontal plane parallel to the horizontal plane of the earth during articulation of the storage unit 101.

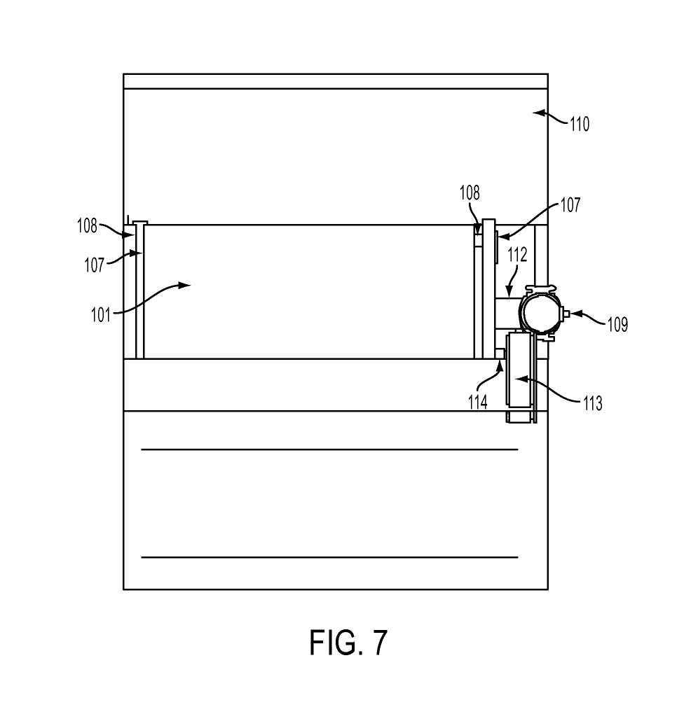

The plane may be maintained through one of many ways known to those familiar with the art of mechanical design. In one embodiment, the storage space may be maintained level and parallel to the earth's horizon with the connection of arms 107 of the articulation device assembly to storage space 101. A pivot connection 108 shown on FIG. 7 may be a connection means used between the arm 107 and the connection on storage space 101, in which the pivot connection 108 of arms 107 to storage space 101 are located above the center of gravity of the storage unit 101. By maintaining this horizontal plane of the storage space 101 parallel to the horizontal plane of the earth during the articulation process the storage space containment items are not dumped or spilled about the storage space 101 during articulation.

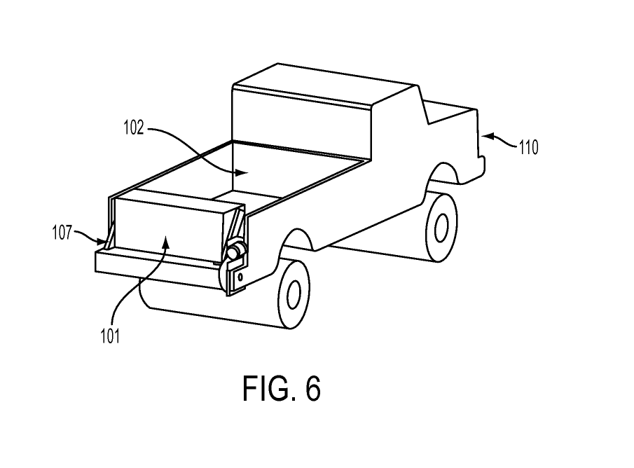

As shown in FIG. 4, storage unit 101 in the docked position of motor vehicle 110 allows the enclosed space of cargo 102 of motor vehicle 110 to hold various items, during transport or otherwise. In the displaced position shown in FIG. 1, storage unit 101 is moved out of the way to provide access to cargo carrying area 102 through the back of motor vehicle 110. In one embodiment, arms 107 comprise electrical over hydraulic actuator pistons. In other embodiments, arms 107 can comprise a portion of an assembly that assists in the articulation of storage unit 101 as illustrated in FIGS. 6, 7, 8, and 9.

One embodiment of the articulation assembly is shown in FIGS. 6, 7, 8, and 9. The articulation assembly may be located inside a motor vehicle cargo space or outside the motor vehicle. In certain embodiments, the articulation device is connected to the motor vehicle 110 and the containment space body 101. In one embodiment, storage unit 101 maintains a level position relative to the pick-up bed during the articulation process thereby not causing tools, and other items located therein to substantially move during articulation. Furthermore, arms 107 allow for any adjustment of the level of storage unit 101 as desired.

Referring to FIG. 5, there is provided another illustration of an embodiment of a containment space or tool box. This figure shows a containment space 101 located such that the entire space of the pick-up bed 102 is free of obstruction of the containment space 101. That is, the top of the storage space 101 is located at least even with or below the bottom of the cargo space 102 floor. FIG. 5 further shows the containment space connected to the electrical power of the truck bed 103. FIG. 5 further shows the containment space 101 being articulated upward to a position shown at 104, wherein the containment space forms an enclosurement of the pick-up bed 102 of motor vehicle 110. FIG. 5 further shows a containment space 101 that is removed from the attachments of the pick-up bed 102, such that a normal tailgate supplied from the pick-up truck manufacture can be returned, or indeed an different containment space can be easily engaged by the articulation assembly such that a containment space body can be configured and or function as a tool box 101 containing tools, a party gate 101 containing food, utensils, beverages, refrigeration, audio and acoustical devices, cooking, and other devices can be supplied in a different articulation containment space body 101 system, allowing the space 106, at the distal end of the pick-up truck to be used for a plurality of containment space bodies 101, each having different functions.

Turning now to FIGS. 6, 7, 8, and 9, a disclosure of one embodiment of an articulating device assembly is illustrated. FIG. 6 illustrates a motor vehicle 110, having a cargo space 102 with a containment space body 101 docked in the storage position inside the storage space 102. FIG. 7 is a view from looking back into the storage are 102 of FIG. 6, in which FIG. 7 shows one embodiment of an articulating device assembly located outside the storage area 102. The articulating device assembly of this embodiment comprises an electrical motor 109, attached to a gear reduction mechanism 112, which is attached to a worm gear device 113, which is attached to a shaft 114. The shaft 114 runs parallel to the width of the containment space 101 and the shaft 114 is attached and fixed to the two lifting arms 107 located on either side of the containment space body 110. A pivot assembly 108 may be connected to the containment space 101 on both sides, which is where the articulating arms 107 may attach to the containment space 101.

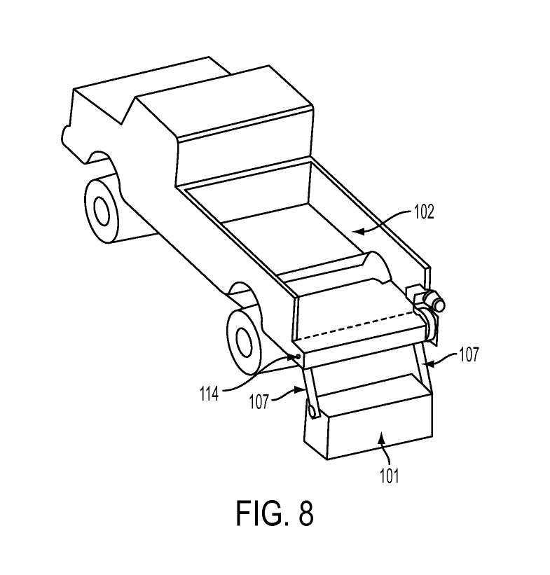

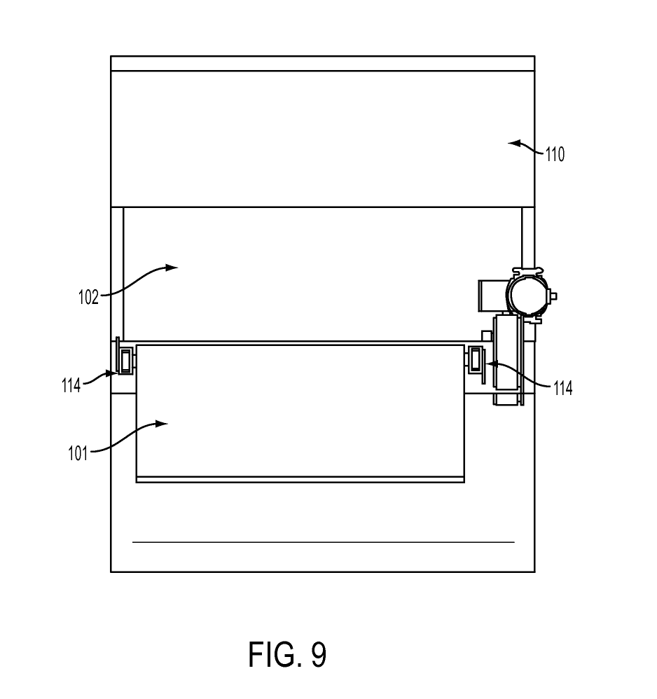

FIG. 7 further illustrates the two lifting arms 107 connected with rotating balls inside the two respective pivot socket connection devices 108 on either side of the containment space body 101. Then, by powering the electrical motor 109 to turn the gears 112 and 113, the shaft 114 is rotated, thereby pulling the two lifting arms 107 causing the containment space body 101 to articulate out from the motor vehicle cargo space 102. The containment space body 101 is thus allowed to rotate within the pivot socket 108 using ball devices attached to lifting arms 107 allowing the containment space body to remain parallel with the earth's horizon during articulation thereby not dislodging items stored in the containment space body. FIG. 8 shows the containment space body 101 articulated out below the motor vehicle cargo space 102 thereby allowing full access to the motor vehicle cargo space 102. FIG. 9 is a view from the rear of motor vehicle 110 looking forward into the motor vehicle cargo space 102, in which the containment space body 101 has been articulated out and below of the vehicle cargo space 102.

In one embodiment, the containment space described above may be used with pick-up bed closure covers, such as those manufactured by Tonneau Covers of Ocala Fla., such that a pick-up may maintain the functionality of a pick-up bed closure cover while also having access to the articulating tool box 101 shown FIG. 5. Therefore, availability and access to the contents of the containment space 101 tool box may be provided through doors 111 shown on FIG. 5 without opening the pick-up cover devices.

Although the above discussion discloses the use of the containment space body 101 for tools, parts, food stuffs, entertainment devices, it is understood that the containment space body 101 can contain batteries to form a large battery storage system, contain liquid fuels like natural gas, cryogenic fluids like liquid natural gas, to power the motor vehicle 110, and any other forms of matter including, but not limited to, cameras, position sensors, audio speakers, display screens, etc. The containment space body 101 and articulation device assembly can then be used to quickly unload and disengage a fuel source containment space body 101, such as a large battery pack, and quickly engage a fully-charged new containment space body battery pack and articulated it to the docking position shown in FIG. 4. This battery pack can then be plugged into the power system of the motor vehicle 110 at a position as shown in FIG. 5 to then power an electrical motor of motor vehicle 110 or removed as shown in position 105 to be charged while another containment space body battery pack is engaged and loaded into the motor vehicle docking position with the articulation device assembly.

Although the present disclosure and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, devices, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, devices, manufacture, compositions of matter, means, methods, or steps. For example, there are many means and methods that can be combined to articulate the containment space, including but not limited to spring forces, hydraulic forces, electrical forces, gravity, human force, and any combination of these and still be encompassed by the methods of this disclosure.

What is claimed is:

1. A method to form an enclosurement space with a motor vehicle storage space using an articulating containment space body, the method comprising:
connecting at least one articulating device assembly to a the motor vehicle;
attaching the at least one articulating device assembly to the containment space body;
supplying power from at least one power source to the at least one articulating device assembly;
articulating a displacement motion of the containment space body relative to the motor vehicle from an enclosurement forming position in the motor vehicle; and
articulating a restoration motion of the containment space to the enclosurement forming position in the motor vehicle.

2. The method of claim 1, further comprising articulating the containment space along a path such that the containment space horizontal plane remains parallel relative to the earth's ground throughout the articulation.

3. The method of claim 2, wherein the displacement or restoration articulation does not substantially change an orientation of material stored inside the containment space body as the containment space is articulated.

4. The method of claim 1, further comprising articulating the containment space body to a position below a bottom of the motor vehicle storage space.

5. The method of claim 1, wherein articulating a restoration motion of the containment space to the enclosurement position in the motor vehicle encloses a portion of the motor vehicle storage space.

6. The method of claim 1, wherein the power source comprises at least electrical power.

7. The method of claim 1, wherein the power source comprises at least hydraulic power.

8. The method of claim 1, wherein the power source comprises at least power from a mechanical device, including at least one of a pulley, a lever, a gear, a spring, and a wheel.

9. The method of claim 1, further comprising powering the motor vehicle from a power source stored within the containment space body.

10. The method of claim 1, further comprising powering the motor vehicle from a fuel source stored within the containment space body.

11. The method of claim 1, further comprising supplying power to the at least one articulating device assembly from a power source from the motor vehicle.

12. The method of claim 1, further comprising refrigerating the containment space.

13. The method of claim 1, further comprising: lowering the containment space from the enclosure position; and removing the containment space from the motor vehicle.

14. The method of claim 1, further comprising interchanging containment space bodies.

15. The method of claim 1, further comprising moving a surface of at least a portion of the containment space body.

16. An apparatus, comprising:
a storage unit configured to be docked to a space on board a motor vehicle thereby forming an enclosurement space; and
an articulating assembly connected to the motor vehicle and configured to articulate the storage unit relative to the motor vehicle.

17. The apparatus of claim 16, further comprising an energy source configured to provide energy to actuate the articulating assembly and move the storage unit relative to the motor vehicle.

18. The apparatus of claim 16, wherein the storage unit comprises electrical connections configured to be connected to an electrical power system of the motor vehicle.

19. The apparatus of claim 16, wherein the storage unit comprises hydraulic connections configured to be connected to a hydraulic power system of the motor vehicle.

20. The apparatus of claim 16, further comprising at least one of a caster and a wheel on a bottom face of the storage unit.

21. The apparatus of claim 16, wherein the storage unit comprises at least one mechanism that allows the passage of materials at least from inside the storage unit to the outside of storage unit.

22. The apparatus of claim 16, wherein the storage unit comprises at least one of an access door, a hatch, and a window to the interior of the storage unit.

23. The apparatus of claim 16, wherein the storage unit is configured to extend out of the formed enclosurement space surrounding the storage unit upon pulling the storage unit.

24. The apparatus of claim 16, wherein the storage unit comprises an electrical battery.

25. The apparatus of claim 16, wherein the storage unit comprises a fuel cell.

26. The apparatus of claim 16, wherein the storage unit comprises a sealed vessel.

27. The apparatus of claim 16, wherein the storage unit comprises electrical outlets and the electrical outlets are connected electrically to an electrical power supply.

28. The apparatus of claim 16, wherein the storage unit comprises electrical devices connected to an electrical system of the motor vehicle.

29. The apparatus of claim 16, wherein the storage unit comprises insulation.

30. A method to articulate containment space bodies for motor vehicles, the method comprising:
connecting at least one powered articulating assembly to the motor vehicle;
connecting the at least one powered articulating assembly to at least one power source;
supplying power from the at least one power source to the articulating assembly;
engaging the containment space body with the articulating assembly; and
articulating the containment space body relative to the motor vehicle.

31. The method of claim 30, wherein the containment space body is articulated on a path such that the horizontal axis of the containment space largely remains parallel to the earth's horizon.

32. The method of claim 30, wherein the containment space body forms an enclosurement space aboard the motor vehicle.

33. The method of claim 30, further comprising interchangeably changing the containment space body assembly attached to the articulating assembly.

34. The method of claims 30, further comprising connecting a cover enclosurement device connected to the motor vehicle to form enclosurement space with the docked containment space body.

35. The method of claim 30, further comprising connecting a video screen device to an outward face of the containment space body.

36. The method of claim 34, wherein the motor vehicle storage space enclosurement device comprises an articulating containment space body.

37. The method of claim 30, further comprising connecting aerodynamic surface members to the containment space body.

38. The method of claim 30, further comprising connecting video cameras to the containment space body.

39. The method of claim 30, further comprising connecting proximity sensors to the containment space body.

40. The method of claim 30, further comprising connecting lights to the containment space body.

41. An apparatus to articulate a containment space body of a motor vehicle in a plane level to the Earth's horizontal plane, the apparatus comprising:
a gear mechanism connected to a shaft, wherein the shaft is connected to at least two lifting arm members, wherein the at least two lifting arm members are configured to allow rotation relative to a pivot mechanism and the at least two lifting arm members, wherein the pivot mechanisms are connected to two sides of the containment space body above a center of gravity of the containment space; and
an electrical motor connected to an electrical power source and the gear mechanism.

42. The apparatus of claim 41, wherein the gear mechanism is configured to move the containment space body between an enclosurement forming position and an extended position.

43. The apparatus of claim 42, wherein the gear mechanism is configured to move the containment space body below a bottom of the motor vehicle in the extended position.

44. The method of claim 41, further comprising functionally attaching a body comprising structural images on the outward surface of a containment space body of a motor vehicle, wherein the image structure comprises securable attachment means to the inside of the containment space body.

45. The method of claim 44, wherein the structural image is configured to be detached and replaced with a different structural image that is then attached to an outward face and secured on an inner face of the containment space body.
